(19) United States
(12) Patent Application Publication
(10) Pub. No.: US 2005/0247005 A1
(43) Pub. Date: Nov. 10, 2005

(54) Rigid ribbon having overall sinusoidal-like waveform shape

(76) Inventor: Chris Mroz, Gig Harbor, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/817,199

(22) Filed: Apr. 1, 2004

(51) Int. Cl. H02J 7/00

(52) U.S. Cl. 52/633

(57) ABSTRACT

A decorative or structural element including a ribbon of material having a body portion and two ends forming a plurality of peaks and troughs in a generally sinusoidal waveform. The body portion defines two major surfaces and two minor perimeter surfaces, wherein the ribbon defines a longitudinal axis. The waveform may have constant or variable amplitudes and/or wavelengths, in various combinations. Moreover, the ribbon may have an overall convex or concave form as well as hybrid convex-concave or concave-convex forms. A flange may be secured to a major surface or a perimeter surface, thereby increasing the structural integrity of the element. In such embodiments, the ribbon may be continuous or discontinuous. In addition, the ribbon may be formed to include longitudinal twists with or without the presence of at least one flange.

### BACKGROUND OF THE INVENTION

1. Description of the Prior Art

Exposed architectural arches, posts and beams have a requirement to be visually appealing, as well as structurally sound. They are either cut from large diameter, solid, old growth timber, or are engineered from laminations of smaller dimensional lumber and glued together. Some of these products may be veneered to improve their appearance. Structural elements that will be hidden from view can be engineered without concern for the visual appearance.

Where wood needs to be shaped into a curved structure, such as in millwork for arches, it may be machined from solid wood, with a major loss of the wood resource as waste. Alternately, it may be laminated from thin strips of wood that has undergone a large reduction in raw material from numerous saw cuts or kerfs. Thus, deficiencies with the prior art include the significant weight of the finished product, inefficient use of wood resources, and a narrow range of aesthetically stimulating products. A need therefore exists for a post, column, arch or beam type product that is visually interesting, light in weight, can be constructed from narrow dimension wood, uses approximately half or less of the wood of a similar size solid or laminated wood product, and can be produced in any needed size and shape. It can also be curved in one or more dimensions. A need further exists with respect to a substitute for dimensional lumber, steel, composites, and other materials to make a significant visual impact as straight or curved pieces in applications, such as timber-frame structures, stair risers, railings, furniture and boats.

SUMMARY OF THE INVENTION

The invention is directed to both structural and non-structural applications, and pertains to formed rigid ribbon waveform compositions and methods for making the same. Embodiments of the invention are characterized as having at least one rigid ribbon of material approximating varieties of sinusoidal waveforms, whether in cross section or overall. Each ribbon has a body portion having a first end and second end (thereby defining a longitudinal axis), a first major surface and a second major surface, and two lateral perimeter surfaces. While the nature of the ribbon may vary from the simple to the complex, certain conventions will be used throughout this patent.

As those persons skilled in the art will appreciate, the naming conventions of a sinusoidal waveform are arbitrarily chosen depending upon one's frame of reference, e.g., a wave peak is an inverted trough in one frame of reference and vice versa. Thus, when describing the invention and embodiments, the inherent frame of reference issues with respect to the naming conventions should be borne in mind.

Each embodiment disclosed herein includes a plurality of convex portions or peaks (Pₙ). Separating each peak from one another is a concave portion or trough (Tₙ). Thus, each peak has two adjacent troughs and each trough has two adjacent peaks. The subscript “n” may denote the specific position and number of the peak or trough relative to an arbitrary beginning point, or may refer generically to all positions as the context dictates. When used to describe a sinusoidal waveform, for example, the designations are as follows when beginning at one end of the waveform: P₁,T₁,P₂,T₂,P₃,T₃,P₄ . . . . This progression can also generally be defined as the following: Pₙ,Tₙ,Pₙ₊₁,Tₙ₊₁,Pₙ₊₂,Tₙ₊₂,Pₙ₊₃ . . . where “n” is any integer (in this case “1”). The wavelength “λ” is the distance between any two adjacent peaks or troughs. The amplitude of any waveform portion is generally the distance from either a peak or trough apex to the normal or equilibrium level.

In one series of embodiments, a ribbon having a simple sinusoidal waveform portion is disclosed, however both the amplitude and wavelength of this waveform may change over the length of the ribbon portion. Moreover, an imaginary line tangentially connecting some or all peaks may be substantially convex, concave, undulating or linear. Similarly, an imaginary line tangentially connecting some or all troughs may be substantially convex, concave, undulating or linear. In addition to the foregoing, at least one flange element may be incorporated with the ribbon: at least one flange element may be joined to one of the peaks, one of the troughs or a portion of the ribbon perimeter. In structural applications, compression loads may be directed to the major surfaces or to the lateral perimeter surfaces, with or without the presence of at least one flange element (although there are many advantages to inclusion of such at least one flange element as will be described below).

In another series of embodiments, the ribbon includes at least one 180° longitudinal axis twist between the ribbon ends, and preferably between a peak Pₙ and a trough Tₙ. Additional embodiments in this series include integer multiples of the 180° longitudinal axis twist, i.e., 360°, 540°, 720° . . . . In all such embodiments, the modifications described above are applicable. Also in this series of embodiments, the ribbon has an overall sinusoidal waveform, although its cross section at any given point may not be sinusoidal.

Embodiments in addition to the foregoing combine aspects of the preceding two series, i.e., the additional embodiment are a heterogeneous mixture of the two series. Thus, a portion of the overall waveform may consist of the first series embodiments while another portion of the overall waveform may consist of the second series embodiments. Additional embodiments include ribbons wherein the perimeter is not planar or the longitudinal axis of the ribbon is not linear, i.e., it is curved, and a plurality of ribbons are linked in a stacked form.

These and other features of the invention can be discerned from a review of the accompanying Figures and the Description of the Invention as set forth below.

### BRIEF DESCRIPTION OF THE DRAWINGS

FIG. 1 is an elevation view of a first series embodiment wherein the wavelength “λ” and amplitude of the sinusoidal curve are relatively constant;

FIG. 2 is an elevation view of the embodiment of FIG. 1;

FIG. 3 is an elevation view of a first series embodiment wherein the wavelength “λ” is relatively constant but the amplitude is variable;

FIG. 4 is an elevation view of a first series embodiment wherein the wavelength “λ” is variable but the amplitude is relatively constant;

FIG. 5 is a plan view of a first series embodiment wherein the ends of the ribbon are in contact with each other to form an annulus or star pattern;

FIG. 6 is an elevation view of a first series embodiment wherein a pair of flanges are affixed to the ribbon peaks and troughs, respectively, to form an arch;

FIG. 7 is an elevation view of a first series embodiment wherein a flange tangentially connecting each peak is convex, and a flange tangentially connecting each trough is planar;

FIG. 8 is an elevation view of a first series embodiment wherein a flange tangentially connecting each peak is concave and a flange tangentially connecting each trough is planar;

FIG. 9 is an elevation view of a first series embodiment wherein a flange tangentially connecting each peak is convex and a flange tangentially connecting each trough is concave;

FIG. 10 is an elevation view of a first series embodiment wherein a flange tangentially connecting each peak is concave and a flange tangentially connecting each trough is convex;

FIG. 11 is an elevation view of a first series embodiment wherein a section of the ribbon is in contact with the flange;

FIG. 12 is an elevation view of a third series embodiment where two ribbons are stacked so that the peaks of one are aligned with the troughs of the other;

FIG. 13 is an elevation view in cross section detailing a preferred mode of securing the ribbon to the flange, namely, by use of a recess in the flange;

FIG. 14 is a perspective view of a first alternative to the first series embodiment wherein a pair of opposing flanges are secured to the ribbon perimeters; and

FIG. 15 is a perspective view of a second series embodiment wherein a longitudinal twist is imparted into the ribbon.

### DESCRIPTION OF THE PREFERRED EMBODIMENTS

The following discussion is presented to enable a person skilled in the art to make and use the invention. Various modifications to the preferred embodiments will be readily apparent to those skilled in the art, and the generic principles herein may be applied to other embodiments and applications without departing from the spirit and scope of the invention as defined by the appended claims. Thus, the invention is not intended to be limited to the embodiments shown, but is to be accorded the widest scope consistent with the principles and features disclosed herein.

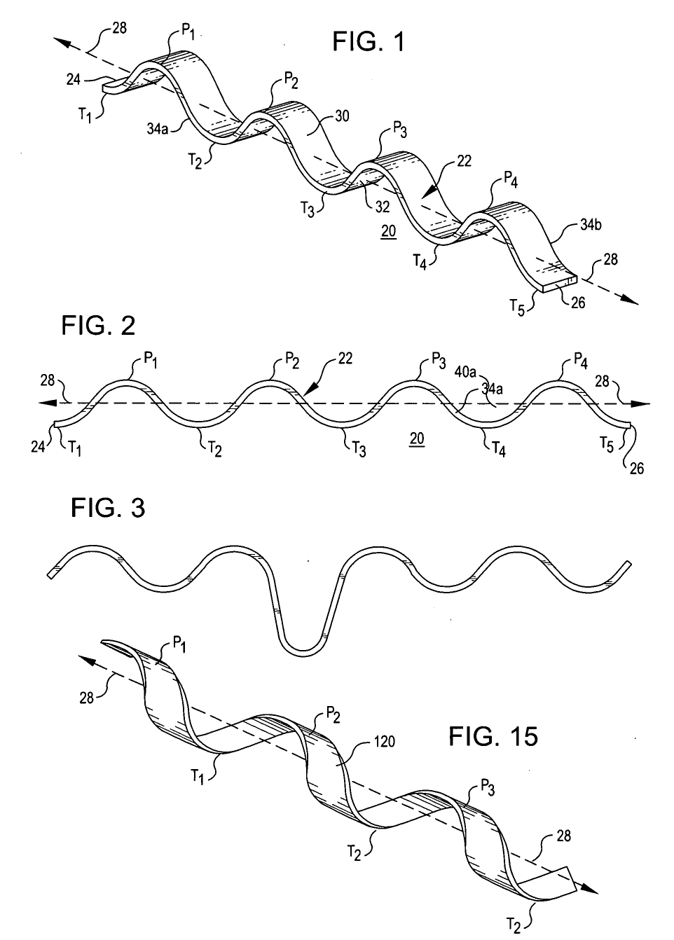

Turning then to the several Figures wherein like numbers indicate like parts, and more particularly to FIGS. 1 and 2, a first series embodiment is shown in perspective. In all disclosed embodiments within this series, ribbon 20 is present. Ribbon 20 has body portion 22 bounded by first end 24 and second end 26 (thereby defining longitudinal axis 28), first major surface 30 and second major surface 32, and lateral perimeter surfaces 34a and 34b. In this illustrated embodiment, ribbon 20 comprises peaks P₁₋₄ and troughs T₁₋₅, which are generally symmetrical to each other, i.e., inversion or rotation of ribbon 20 will not materially alter its appearance.

Ribbon 20 is preferably constructed from laminated wood or compressed wood, the latter being a product resulting from a proprietary process owned by Dansk Teknologisk Institut of Taastrup, Denmark, and disclosed in U.S. Pat. No. 5,190,088, which is incorporated herein by reference. In this process, hardwood having a preferable moisture content of 20-25% is heated and softened (plasticized) so that it can be compressed in the longitudinal direction. Heating can be done by means of steam or radio frequency (RF), which preferably brings the wood to a temperature of about 100° C. After suitable heating, the wood is longitudinally compressed approximately 20-25% in a special horizontal hydraulic press for about 10 minutes. As a result of this axial compression, the axial fiber cell walls are cross folded and the solid wood can be bent or stored for future bending. Once bent, the formed wood can be cured by various means such as air drying, radiant heat drying, convection heat drying, RF drying, or microwave drying. Bending of the wood can be accomplished using any variety of means such as manual bending by hand, bending with clamps or vice, press bending using hydraulic or air cylinders, continuous bending using, e.g., rollers, and bending assisted with heat and pressure (heat may reduce pressure requirements and assist drying).

In the present embodiment, a plank of compressed wood is subjected to bending to form the illustrated ribbon. Alternately, thin strips of wood may be bent and glued together to form a laminate. Again,-the means used to shape the wood plank are considered a design choice. All that is required is that the final structure includes the intended geometric characteristics. In this embodiment, the wavelength “λ” and amplitude of the sinusoidal curve are relatively constant: the peak to peak distance is generally uniform over the length of the ribbon, and a tangential line connecting each peak is generally parallel to a tangential line connecting each trough.

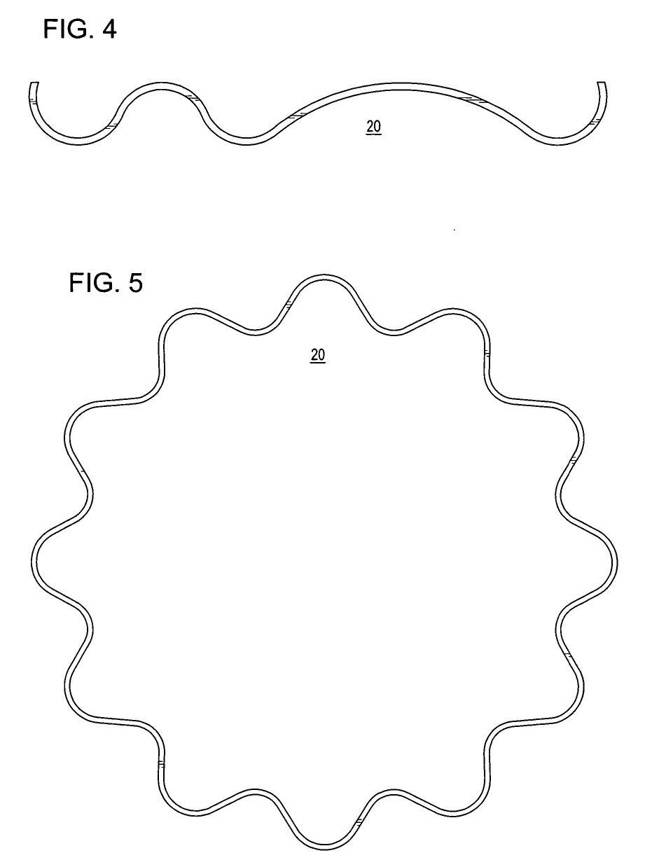

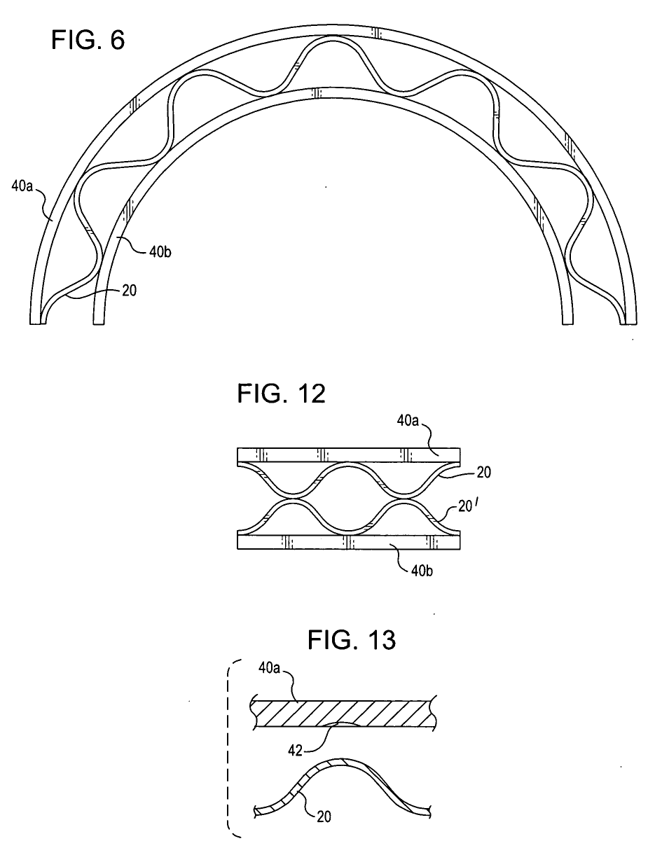

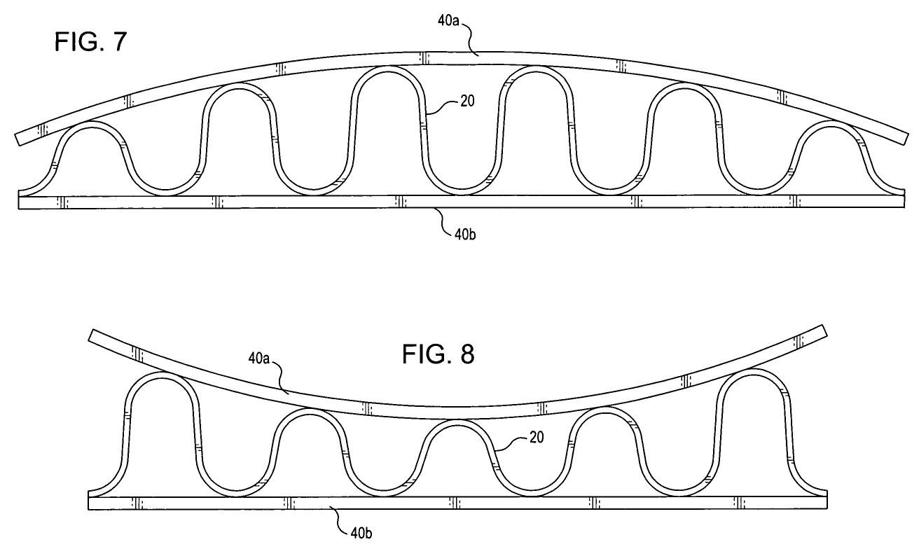

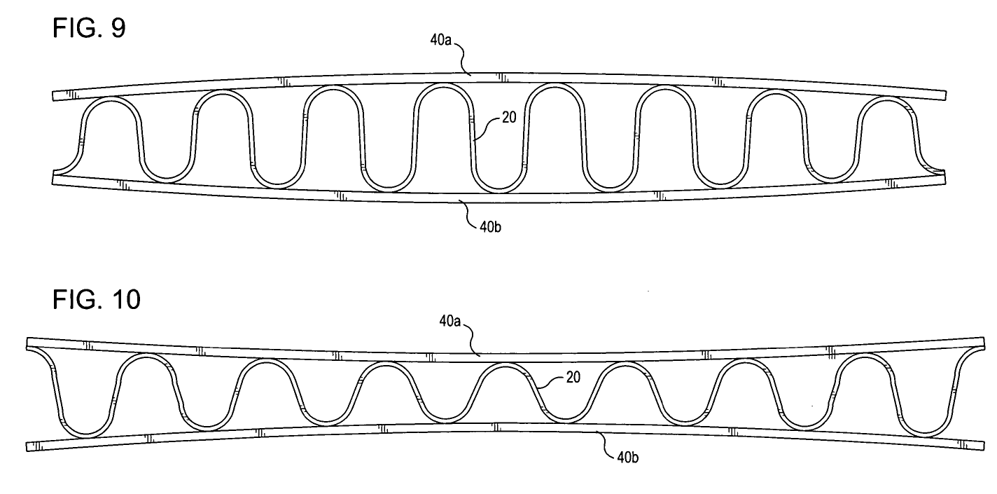

As noted previously, it is possible and often desirable to modify the nature of ribbon 20. Modifications include changes to the amplitude of ribbon 20 as shown in FIG. 3; changes to the wavelength “λ” of ribbon 20 as shown in FIG. 4; changes to upper peak and lower trough tangents as shown in FIGS. 6-10, i.e., tangent of peaks is convex or concave, tangent of troughs is convex or concave, or combinations of the two; and the addition of flanges 40 to various portions of ribbon 20 as shown in FIGS. 6-11 and 14. As skilled practitioners will appreciate, a single ribbon may incorporate more than one of these modifications, and often would depending upon the application for which the ribbon will be used.

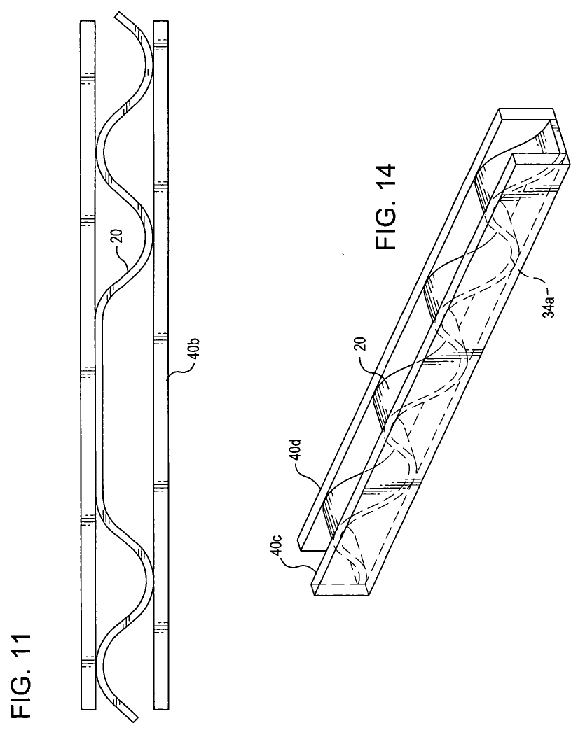

The incorporation of at least one flange fixedly attached to peaks Pₙ, troughs Tₙ, as shown in FIGS. 6-11, or to perimeter 34 as shown in FIG. 14 is particularly attractive for structural purposes. By securing flanges 40ₐ and 40b to peaks Pₙ and troughs Tₙ respectively, a truss-like and/or I-beam like structure is developed. In so doing, compression loads on peaks Pₙ reduce longitudinal deflection of ribbon 20. Similarly, by securing two flanges 40c and 40d to perimeters 34a and 34b, longitudinal deflection is again arrested to some degree. Again, those persons skilled in the art will appreciate that one flange may be sufficient in certain applications and that a torsion box structure can be created by enclosing and attaching the ribbon on all sides. Moreover, the flanges can be constructed from any desirable material, including plastics such as clear plastic.

Attachment of ribbon 20 to a flange 40 can be carried out by use of mechanical fasteners, e.g., wood screws, bolt and nut combinations, brads, nails, dowels, etc., by use of adhesives, e.g., epoxies, glues, etc., or combinations thereof. Moreover, it may be desirable to create a recess in each flange at its point of contact with the ribbon to increase the strength of the linkage between these two components. As shown in FIG. 13, recess 42 is formed in a flange 40 to complementarily receive at least a portion of peak Pₙ. By so doing, resistance to lateral loads, e.g., shear, can be increased.

FIG. 15 shows a second series embodiment in perspective. Unlike the first series embodiments, this second series illustrates that the minor axis of the ribbon need not be parallel at all points along the ribbon. Here, ribbon 120 has been rotated or twisted along its longitudinal axis while still maintaining an overall sinusoidal shape. As with ribbon 20, it too is constructed from compressed or laminated wood.

While the number of rotations or twists between any Pₙ and Tₙ is often a matter of design choice, if ribbon 120 is to be used in structural applications it is desirable to have a single plane common to all surfaces that will bear loads. For example, ribbon 120 in FIG. 15 has planar portions at each peak and trough, an alternative embodiment (not shown) has planar portions on lateral sides of the ribbon.

It should be noted that the rotations or twists imparted in ribbon 120 need not be regular (the number of rotations or twists per segment of ribbon 120 may be irregular) nor of the same direction (the rotation or twist in one wavelength or fraction thereof may be in on direction, and reversed in the other). In most instances, if a flange element or other planar member is to be used, or if the ribbon is to be used in a structural application, then it becomes desirable to maintain a suitable mating surface on the ribbon. This usually, but not necessarily, means that the contacting portion of the ribbon is also planar as shown in all illustrated embodiments.

In all embodiments described so far, compressed or laminated wood has been used. However, those persons skilled in the art will readily appreciate the ability to use alternative materials for construction of the ribbon and flanges. In particular, any form of bendable, non-memory materials are considered viable alternatives. These include many metals, laminates constructed from wood, solid woods, and plastics (thermoplastics and thermosetting plastics). However, best results can be achieved by using substantially homogenous materials such as compressed woods, solid woods, and thermoplastics, or laminated materials, especially wood laminates.

Moreover, combinations of the first and second series embodiments can be constructed. A plurality of ribbons can be combined in various ways to form additional structures. FIG. 12 shows a two row or stacked configuration wherein the second ribbon contacts the first ribbon peak to trough (offset stack); an alternative configuration (not shown) has a laminated ribbon comprising a first ribbon laminated to a second ribbon in a nested form (registered stack). Still other combinations can include a segmented construction, or one where the substantially sinusoidal waveform is interrupted by another geometric configuration, e.g., FIG. 11.

1. A decorative or structural element comprising:
a unitary ribbon comprising a body portion having a length (L) between a first end and a second end, thereby defining a longitudinal axis, a width (W) and a thickness (D);
first and second major surfaces, and first and second lateral perimeter surfaces having a width substantially equal to (D) and a length substantially equal to (L); and
a plurality of peaks (Pₙ) and troughs (Tₙ) between the first and second ends generally forming a sinusoidal waveform.

2. The element of claim 1 wherein the amplitude and wavelength “λ” are generally constant from the first end to the second end of the ribbon.

3. The element of claim 1 wherein a tangent contacting each peak Pₙ is characterized as one of convex, concave, undulating or linear.

4. The element of claim 1 wherein a tangent contacting each trough Tₙ is characterized as one of convex, concave, undulating or linear.

5. The element of claim 1 wherein a tangent contacting each peak Pₙ is characterized as one of convex, concave, undulating or linear and wherein a tangent contacting each trough Tₙ is characterized as one of convex, concave, undulating or linear.

6. The element of claim 1 wherein the amplitude is generally constant but the wavelength “λ” is variable from the first end to the second end.

7. The element of claim 1 wherein the wavelength “λ” is generally constant but the amplitude is variable from the first end to the second end.

8. The element of claim 1 wherein a tangent contacting each peak Pₙ is characterized as convex and a tangent contacting each trough Tₙ is characterized as concave.

9. The element of claim 8 wherein one of the wavelength “λ” or the amplitude is generally constant.

10. The element of claim 8 wherein a plurality of lines bisecting a plurality of peaks or troughs are skewed relative to one another.

11. The element of claim 1 wherein a tangent contacting each peak Pₙ is characterized as one of convex or concave, and a tangent contacting each trough Tₙ is characterized as linear.

12. The element of claim 11 wherein the wavelength “λ” is generally constant.

13. The element of claim 1 further comprising a second generally sinusoidal waveform ribbon adjacent to the first ribbon wherein at least some of the troughs of the second ribbon are in contact with at least some of the peaks of the first ribbon to form an offset stack.

14. The element of claim 13 further comprising at least one secure linkage between one contacting peak-trough pair to prevent relative movement there between.

15. The element of claim 1 further comprising a plurality of generally sinusoidal waveform ribbons arranged to create an offset stack with respect to the first ribbon.

16. The element of claim 1 further comprising a second generally sinusoidal waveform ribbon attached to the first ribbon wherein at least some of the troughs of the second ribbon are in contact with at least some of the troughs of the first ribbon to form a registered stack.

17. The element of claim 16 wherein at least part of the first ribbon surface adjacent to the second ribbon is secured to part of the second ribbon surface adjacent to the first ribbon to create a laminate structure.

18. The element of claim 1 further comprising a plurality of generally sinusoidal waveform ribbons arranged to create a registered stack with respect to the first ribbon.

19. The element of claim 1 wherein the first end is in contact with the second end.

20. The element of claim 1 wherein the generally sinusoidal waveform is interrupted by a non-sinusoidal waveform segment.

21. A decorative or structural element comprising:
a unitary ribbon comprising a body portion having a length (L) between a first end and a second end, thereby defining a longitudinal axis, a width (W) and a thickness (D);
first and second major surfaces, and first and second lateral perimeter surfaces having a width substantially equal to (D) and a length substantially equal to (L);
a plurality of peaks (Pₙ) and troughs (Tₙ) between the first and second ends generally forming a sinusoidal waveform; and
a first flange fixedly attached to the element and contacting one of at least some of the plurality of peaks, at least some of the plurality of troughs, or at least one of the lateral perimeter surfaces.

22. The element of claim 21 wherein the amplitude and wavelength “λ” are generally constant from the first end to the second end of the ribbon.

23. The element of claim 21 wherein the first flange contacts at least some peaks Pₙ and is characterized as one of convex, concave, undulating or linear.

24. The element of claim 21 wherein the first flange contacts at least some troughs Tₙ and is characterized as one of convex, concave, undulating or linear.

25. The element of claim 21 wherein the first flange contacts at least some peaks Pₙ and is characterized as one of convex, concave, undulating or linear, and wherein a second flange contacts at least some troughs Tₙ and is characterized as one of convex, concave, undulating or linear.

26. The element of claim 21 wherein the amplitude is generally constant but the wavelength “λ” is variable from the first end to the second end.

27. The element of claim 21 wherein the wavelength “λ” is generally constant but the amplitude is variable from the first end to the second end.

28. The element of claim 21 further comprising a second generally sinusoidal waveform ribbon adjacent to the first ribbon wherein at least some of the troughs of the second ribbon are in contact with at least some of the peaks of the first ribbon to form an offset stack.

29. The element of claim 21 further comprising a second generally sinusoidal waveform ribbon attached to the first ribbon wherein at least some of the troughs of the second ribbon are in contact with at least some of the troughs of the first ribbon to form a registered stack.

30. The element of claim 21 wherein the first end is in contact with the second end.

31. A decorative or structural element comprising:
a unitary ribbon comprising a body portion having a length (L) between a first end and a second end, thereby defining a longitudinal axis, a width (W) and a thickness (D);
first and second major surfaces, and first and second lateral perimeter surfaces having a width substantially equal to (D) and a length substantially equal to (L); and
a plurality of peaks (Pₙ) and troughs (Tₙ) between the first and second ends generally forming a sinusoidal waveform wherein the ribbon includes at least one longitudinal twist between the first end and the second end.

32. The element of claim 31 wherein the at least one longitudinal twist is between two adjacent peaks.

33. The element of claim 32 wherein the at least one longitudinal twist is between a first peak and an adjacent trough.

34. The element of claim 33 wherein the longitudinal twist is an integer multiple of 180°.
